(19) United States
(12) Patent Application Publication
(10) Pub. No.: US 2021/0125193 A1
(43) Pub. Date: Apr. 29, 2021

(54) DELIVERY AUTHENTICATION SYSTEM

(71) Applicant: DEGO MALAYSIA SDN BHD, WILAYAH PERSEKUTUAN KUALA (MY)

(72) Inventor: NABIL FEISAL BAMADHAJ, WILAYAH PERSEKUTUAN KUALA LUMPUR (MY)

(21) Appl. No.: 16/961,507

(22) PCT Filed: Apr. 22, 2020
(86) PCT No.: PCT/MY2020/050024

§ 371 Date: Jul. 10, 2020

(30) Foreign Application Priority Data
Oct. 1, 2019 (MY) PI2019005801

(51) Int. Cl. G06Q 30/00; G06Q 10/08; G06F 21/60; G06F 16/22; H04L 29/06; G06K 9/00

(52) U.S. Cl. CPC G06Q 30/0185; G06Q 10/0838; G06F 21/602; G06K 9/00087; H04L 63/0861; G06K 9/00013; G06F 16/22

(57) ABSTRACT

A system for authentication of delivery service includes a processing module for processing programs linked to the system; a biometric authentication device positioned at a delivery location for authentication at least one individual performing the delivery service; a matching module for performing matching analysis on the individual performing the delivery service using a server. The server stores a database of a plurality of delivery service providers connected to the matching module. The matching module retrieves supplier data of the individual from the biometric authentication device to analyse the supplier data with client data stored or assigned of at least one client relating to the delivery service performed by the individual, in which the biometric authentication device is linked to at least one client receiving the delivery service, and the device having a network card for establishing connection to a network.

### TECHNICAL FIELD

The present invention relates to a method for attestation of delivery by a courier service prover representative by using an individual's biometric identifiers.

### BACKGROUND OF INVENTION

Presently, the adaptation of mobile device technology in our daily living is widespread alongside the blossoming growth of online retailer. Consumers can conveniently shop for goods online from their homes, and are spoiled for choice by just one click away. The nature of parcels can also vary, including documents, bonds, chemicals, and biological agents coming from various senders. Hence, the delivery process is of utmost importance in ensuring that parcels arrive upon the doorstep of an intended recipient within a reasonable timeframe, undamaged, and safely.

Courier services continue to benefit from this particular consumer habit. In many instances, the ‘pen-and-paper’ method of attesting delivery receipt is still practiced by courier services. Courier services are also increasingly reliant on the digital attestation of receipt by both the courier representative and parcel recipient to save time during the delivery process, and for the generation of proof of delivery for both parties. However, these methods require signatures of authorised recipients or their representatives. This renders the delivery process susceptible to fraud should an unauthorised recipient gains access to the signature and other sensitive information belonging to the true recipient, as these may be forged to attest a successful delivery of goods.

The present invention seeks to exclude requiring signatures of authorised recipients and their representatives for the attestation of delivery. The invention instead requires a biometric identifier (i.e. fingerprints) of a courier representative at to confirm the successful delivery of a parcel from a sender to an authorised location after the parcel has been inspected for damages by a recipient upon arrival to its destination.

### SUMMARY OF INVENTION

The present invention relates to a system for authentication of delivery service, comprising: a processing module for processing programs linked to the system; a biometric authentication device positioned at a delivery location for authentication at least one individual performing the delivery service; a matching module for performing matching analysis on the individual performing the delivery service using a server, wherein the server stores a database of a plurality of delivery service providers connected to the matching module; characterized in that the matching module retrieve at least one supplier data of the individual from the biometric authentication device to analyse the supplier data with at least one client data stored or assigned of at least one client relating to the delivery service performed by the individual, in which the biometric authentication device is linked to at least one client receiving the delivery service, and the device having a network card for establishing connection to a network, such that the supplier data are remotely transmittable via the network to server, and retrievable at least one result of the matching analysis of the client data and the supplier data via the network from the server for notifying the result of delivery service to the delivery service providers, the client or recipient or at least one personnel from the requested delivery service.

A further embodiment of the system for authentication of delivery service comprising a delivery device for use of a courier representative to register the individual performing the delivery service into the system.

A further embodiment of the system for authentication of delivery service comprising a user-authorised electronic mobile device for storing encrypted data and transmitted into the server.

Preferably, the biometric authentication device is installed in a premise acting as an authorised delivery location.

Preferably, the biometric authentication device has a fingerprint sensor.

Preferably, the biometric authentication device has a camera, a display panel, a Global Positioning System (GPS), a wireless connection, a power supply connection, a battery, and a memory storage.

Preferably, the biometric authentication device has a flat finishing surface on one end of the device, and houses computing parts of the device at the opposing end in a casing attached to the other end.

Preferably, the device implements an identification policy against biometric signatures that are generated by the system to manage, including but not limited to the creating and comparing, of biometric signature data on the log database.

A further embodiment of the system for authentication of delivery service comprising a mobile device linked to the biometric authentication device or fingerprint sensor for use of the client or recipient to acknowledge the delivery service.

The present invention consists of features and a combination of parts hereinafter fully described and illustrated in the accompanying drawings, it being understood that various changes in the details may be made without departing from the scope of the invention or sacrificing any of the advantages of the present invention.

### BRIEF DESCRIPTION OF DRAWINGS

To further clarify various aspects of some embodiments of the present invention, a more particular description of the invention will be rendered by references to specific embodiments thereof, which are illustrated in the appended drawings. It is appreciated that these drawings depict only typical embodiments of the invention and are therefore not to be considered limiting of its scope. The invention will be described and explained with additional specificity and detail through the accompanying drawings in which:

FIG. 1 shows data transfer from a biometric authentication device within a delivery service system during an attestation of delivery.

FIG. 2 shows planar and side views of the biometric authentication device.

FIG. 3 shows the process flow of an initial one-time setup and sign-up of an electronic mobile device for attesting delivery.

FIG. 4 shows the process flow of biometric input processing by the biometric authentication device.

FIG. 5 shows the process flow of the pay-per-verification delivery system.

### DETAILED DESCRIPTION OF THE PREFERRED EMBODIMENTS

The present invention may be embodied in other specific forms without departing from its essential characteristics. The described embodiments are to be considered in all respects only as illustrative and not restrictive. The scope of the invention is, therefore indicated by the appended claims rather than by the foregoing description. All changes, which come within the meaning and range of equivalency of the claims, are to be embraced within their scope.

In light of the above-mentioned problem associated with delivery authentication systems, the present invention is to disclose a method of attesting successful deliveries of parcels by a courier representative using his or her biometric identifier, which are their fingerprints, using a biometric authentication device or fingerprint sensor. The biometric data transfer takes place through encrypted session-based requests within trusted execution environments.

An embodiment of the method for authenticating or attesting a successful delivery of a parcel by a courier representative at an authorised location comprises four components, namely, the fingerprint authentication device, trusted mobile electronic device, encrypted device network, and cloud server.

Further, the mobile electronic device is that used in the present invention is an embodiment of a fingerprint sensor, processor, display, micro-controller, communication interface, network interface, operating system, camera, Global Positioning System (GPS), battery, electrical conductors, and memory.

Preferably, the fingerprint sensor resembles, but not limited to, a common electrical switch in terms of appearance.

Preferably, the fingerprint sensor is capable of connecting to wireless local area and cellular network devices.

Preferably, the network interface of the electronic device is capable of connecting to wireless local area and cellular network devices.

Preferably, the cloud server consists of an authentication application, database, server, and applications from third-party courier service providers.

The present invention includes an embodiment of a plurality of devices and processes for the attestation of a successful delivery by a courier representative at an authorised location. The first requirement of the invention is a mobile electronic device comprising a processor, display, micro-controller, communication interface, operating system, camera, Global Positioning System (GPS), battery, electrical conductors, and memory. The second requirement is an encrypted device network that is supplied by a telco network provider of choice. The third requirement is a cloud system comprising a service application, database, server, and third-party application.

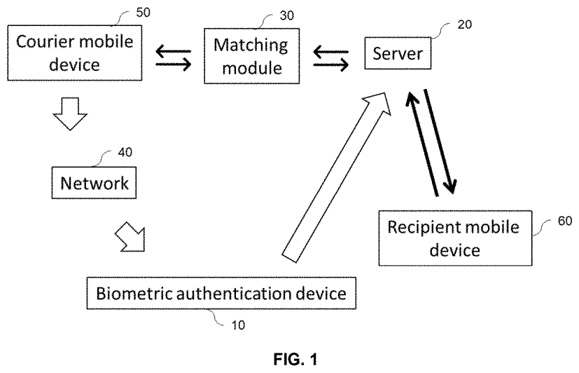

FIG. 1 shows data transfer from a biometric authentication device within a delivery service system during an attestation of delivery. The process involves data transmission between the biometric authentication device (10) having a fingerprint sensor connected to a network (40), a server (20) having a database that stores information on a plurality of delivery service providers, a matching module (30) that verifies information that are inputted by an individual performing the delivery using a courier mobile device (50), or an entity receiving the delivery using a recipient mobile device (60) by request of the delivery system. The individual who is performing the delivery is registered on the system prior to use.

The biometric authentication device (10) having a fingerprint sensor is placed within the vicinity of a premise that is acting as an authorised location for deliveries. The device (10) has a network card which enables the device (10) to connect to a network (40), preferably a wide area network (WAN). The device (10) is connected to a server (20) for continuous access and syncing of information on a plurality of delivery service providers.

An authorised courier mobile device (50) is carried by an individual performing a delivery. When the individual performing the delivery has completed the delivery, he or she is required to present his or her fingerprint to the biometric authentication device (10). The server (20) of the delivery system syncs delivery data to the biometric authentication device (10), and courier mobile device (50) for attesting a successful delivery. Once completed, the server generates a delivery receipt to be sent to the entity who receives the delivery via email, or notify a successful delivery via a notification on a recipient mobile device (60).

The matching module (30) serves as a point-of-access, and verification tool of all information that is inputted into the system for storing on the server (20), including information on mobile phone numbers of authorised mobile devices, and premise locations.

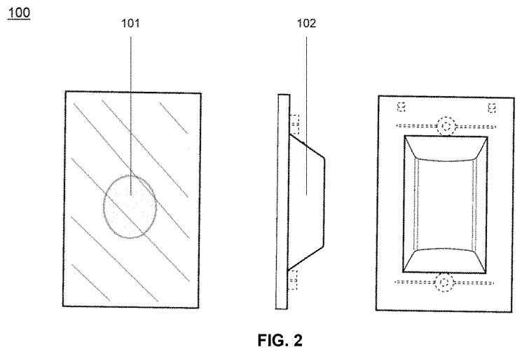

FIG. 2 shows the planar and profile views of a biometric authentication device (100) or fingerprint sensor for the attestation of a successful delivery by a courier representative. The sensor has an appearance similar to common electrical switches, and is placed within the premise of an authorised location.

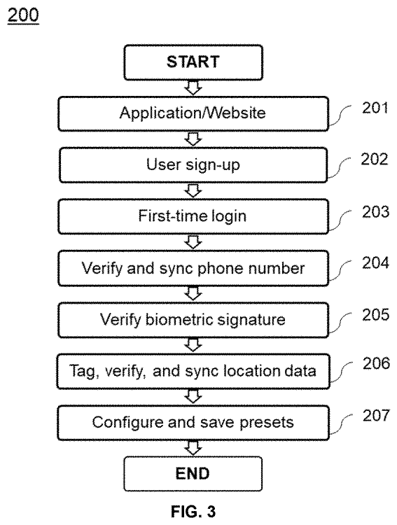

FIG. 3 illustrates the process flow of an initial one-time setup and sign-up of an electronic mobile device by a user (200). The user has to open the application and/or website of the authentication service (201), and proceed to signing up (202) by providing the form fields with the necessary information such as name, email address, company address, and contact information. After the signing-up is completed, the user will be sent a verification email to their registered email address to confirm the previous registration by logging into the application and/or website for the first time (203). Once the verification is completed, the application and/or website will automatically sync with their phone number (204). Next, the user shall input and verify their biometric identifier through the service application (205) using a biometric authentication device (100) or fingerprint sensor before continuing to tag, verify, and sync their present location data (206). Once completed, a user shall configure miscellaneous settings integrated into the application whenever necessary (207). This process is performed using a matching module, where the matching module performs matching analysis on the individual performing the delivery service using a server, wherein the server stores database of plurality delivery service providers connected to the computing module. The matching module retrieves supplier data of the individual from the system or device to analyse the supplier data with a database of client-data stored or assigned of plurality of client relating to the delivery service performed by the individual. Thereafter, the biometric authentication device (100) or fingerprint sensor linked to at least one client receives the delivery service, and the device having a network card for establishing connection to a network, for transmitting the supplier data remotely via the network to server, and retrieve result of the matching analysis of the client-data and the supplier data via the network from the server for notifying the result of delivery service to the delivery service providers, the client or recipient or at least one personal from the requested delivery service.

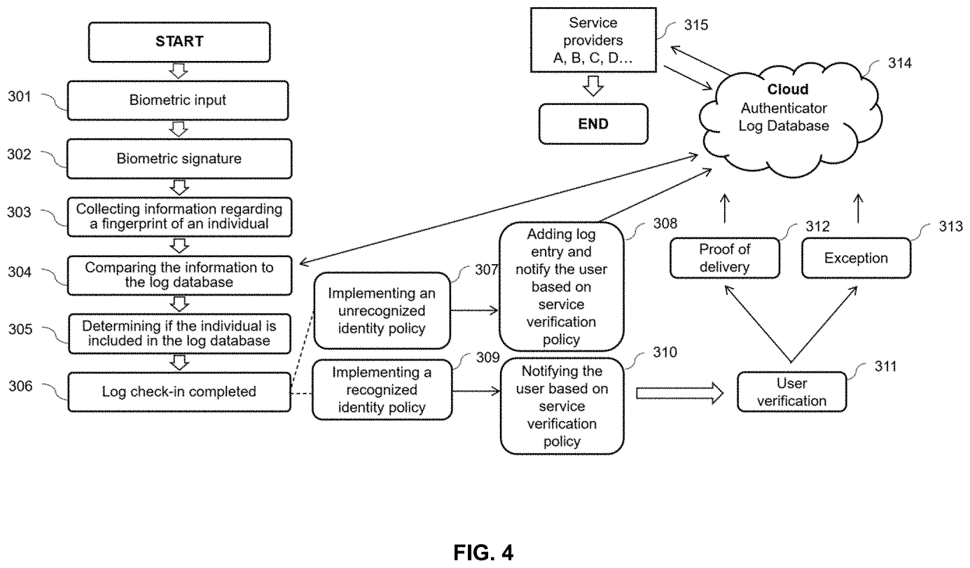

FIG. 4 illustrates the flow of the biometric input processing by a biometric authentication device (100) having a fingerprint sensor. A user starts with presenting the biometric input that is the fingerprint on the screen acting as a sensor on an electronic mobile device while the service application is running on the foreground (301). The biometric input becomes a digital biometric signature (302), and the information is collected (303) by the log database. Upon entering the log database, the biometric signature is compared with the ones that are stored there (304) at a given time. This is carried out to determine if the individual is already included in the log database prior (305) to the present attempt. The log check-in is complete once the step finished (306). The process then moves towards the implementation of identity policy, in which the log entry of an unrecognised (hence new) biometric signature (307) is added to the log database of the cloud server (308 and 314). The new user is notified of this entry through the service verification policy (308). The user shall repeat the process of attesting for delivery once his or her biometric signature is successfully stored into the log database. If the system recognises a biometric signature from a returning user, a recognised identity policy is implemented (309). The returning user is notified of the present attempt also through the service verification policy (310 and 311). When an attempt to attest for delivery is successful, a proof of delivery for a parcel is generated (312), and is logged into the database (314). If an attempt is unsuccessful for any reason (313), the information is also logged into the database (314). The attempt to attest for delivery shall be repeated until it is successful for every time an attempt is made, the information is logged into the database (314). The cloud server in which the log database is housed shall be made accessible to all authorised persons of respective courier service providers (315).

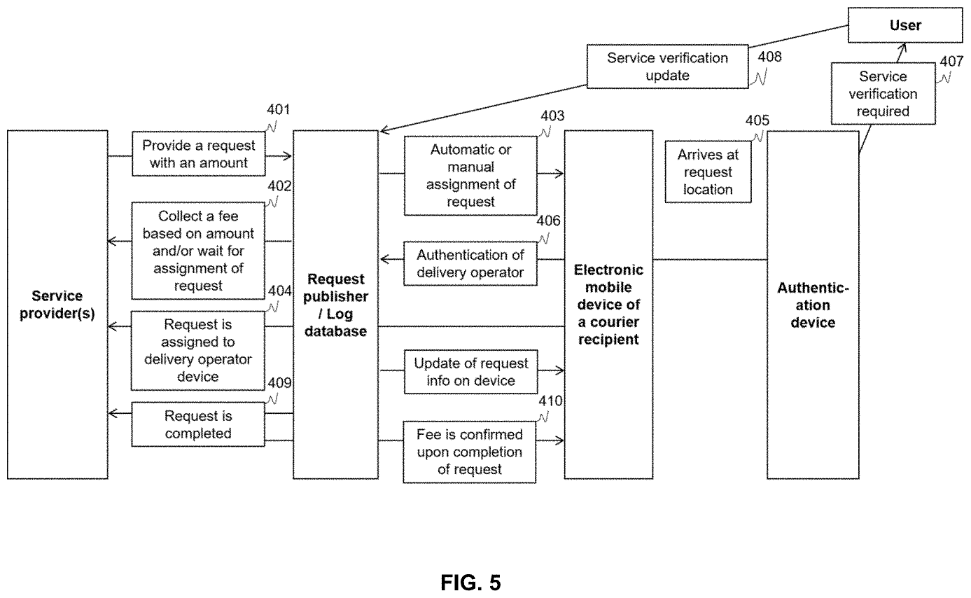

FIG. 5 illustrates the process flow of the pay-per-verification delivery system of the present invention. The process starts with a delivery request being issued to courier service providers. The service providers issues and collects a fee for a delivery request before assigning it to a courier representative either automatically or manually (401, 402, 403). All delivery requests and their corresponding issued fees are logged into the database. Next, the delivery request is assigned to a courier representative through his or her mobile electronic device (404). After the assignment, the courier representative attempts a delivery and (405) and attests for a successful delivery by presenting his or her fingerprint to the biometric authentication device (406) or fingerprint sensor that has been installed at the destination premise. Once this is done, the delivery request is complete (407), and the courier service provider shall confirm the fee that has been initially issued for the request (408).

From the preceding description of the preferred embodiments, it is evident that the objects of the invention are attained by the present invention. Although this invention has been described and illustrated in detail, it is to be clearly understood that the same is by way of illustration and example only and is not to be taken by way of limitation. Therefore, the spirit and scope of this invention are to be limited only by the terms of the appended claims.

1. A system for authentication of delivery service, comprising:
a processing module for processing programs linked to the system;
a biometric authentication device positioned at a delivery location for authentication at least one individual performing the delivery service;
a matching module for performing matching analysis on the individual performing the delivery service using a server, wherein the server stores a database of a plurality of delivery service providers connected to the matching module;
characterized in that the matching module retrieve at least one supplier data of the individual from the biometric authentication device to analyse the supplier data with at least one client data stored or assigned of at least one client relating to the delivery service performed by the individual, in which the biometric authentication device is linked to at least one client receiving the delivery service, and the device having a network card for establishing connection to a network, such that the supplier data are remotely transmittable via the network to server, and retrievable at least one result of the matching analysis of the client data and the supplier data via the network from the server for notifying the result of delivery service to the delivery service providers, the client or recipient or at least one personnel from the requested delivery service.

2. The system for authentication of delivery service according to claim 1, further comprising a delivery device for use of a courier representative to register the individual performing the delivery service into the system.

3. The system for authentication of delivery service according to claim 1, further comprising a user-authorised courier mobile device for storing encrypted data to be transmitted to the server.

4. The system for authentication of delivery service according to claim 1, wherein the biometric authentication device is installed in a premise acting as an authorised delivery location.

5. The system for authentication of delivery service according to claim 1, wherein the biometric authentication device has fingerprint sensor.

6. The system for authentication of delivery service according to claim 1, wherein the biometric authentication device has a camera, a display panel, a Global Positioning System (GPS), a wireless connection, a power supply connection, a battery, and a memory storage.

7. The system for authentication of delivery service according to claim 1, wherein the biometric authentication device has a flat finishing surface on one end of the device, and houses computing parts of the device at the opposing end in a casing attached to the other end.

8. The system for authentication of delivery service according to claim 1, wherein the biometric authentication device implements an identification policy against biometric signatures that are generated by the system to manage biometric signatures, including the creating and comparing of biometric signature data on the log database.

9. The system for authentication of delivery service according to claim 1, further comprising a recipient mobile device linked to the biometric authentication device for use by the client or recipient to acknowledge the delivery service.

10. The system for authentication of delivery service according to claim 1, further comprising a courier mobile device linked to the server for use by the individual performing the delivery service or client to perform attestation of delivery on the biometric authentication device.
